(19) United States
(12) Patent Application Publication
(10) Pub. No.: US 2022/0145051 A1
(43) Pub. Date: May 12, 2022

(54) THERMOPLASTIC OLEFIN COMPOSITION

(71) Applicant: Dow Global Technologies LLC, Midland, MI (US)

(72) Inventors: Parvinder S. Walia, Midland, MI (US); Mark P. Allen, Bruce Township, MI (US)

(21) Appl. No.: 17/433,472

(22) PCT Filed: Apr. 7, 2020
(86) PCT No.: PCT/US2020/027041

§ 371 Date: Aug. 24, 2021

Related U.S. Application Data
(60) Provisional application No. 62/834,994, filed on Apr. 17, 2019.

(51) Int. Cl. C08L 23/08

(52) U.S. Cl. CPC C08L 23/0823; C08L 2207/04

(57) ABSTRACT

A thermoplastic olefin composition including (a) an elastomer having a melt flow rate of less than 1.0 dg/min and a high melt strength, in combination with (b) a polypropylene with a melt flow rate of greater than 35 dg/min; a process for making the above composition; and an article made from the above composition.

### FIELD

The present invention relates to a thermoplastic olefin composition; and more specifically, the present invention relates to a thermoplastic olefin composition prepared by combining a high melt flow polypropylene with a high melt strength polyolefin elastomer.

### BACKGROUND

Automotive interiors are a key area of differentiation for automotive OEM. Thermoplastic olefin (TPO) soft skins are often used to cover hard surfaces in the interior of automobiles such as instrument and door panels; and the TPO skins are often used to replace leather surfaces while achieving leather-like haptics and aesthetics. Aesthetically, the surfaces of TPO skins typically require a low gloss property to provide a luxurious appearance. Mechanically, TPO skins can also be used as a cover for airbag placement under the TPO skin, and thus it is desirable for the TPO skins to tear easily without ballooning during deployment of the airbag. From a process perspective, when known TPO skins are extruded, using high melt strength Polyolefin Elastomers (POEs) in combination with low melt index polypropylene, the TPO skins exhibit high pressure and torque during extrusion, which might limit throughput values to less than the rated conditions for the extrusion equipment. Therefore, a compounded TPO should have a good melt strength, so parts made from the compounded TPO do not thin or tear during forming.

Traditional solutions for increasing the melt strength of TPO soft skin applications include using: (1) thermoplastic vulcanizates, (2) rheology modification, or (3) a compounded TPO including a combination of a high melt strength POE with a fraction of low melt flow polypropylene. Thermoplastic vulcanizates and rheology modification involves a reactive extrusion process, which can add significantly to the cost of the resulting TPO skin product. In addition, reactive extrusion often involves additional compounds such as phenolics and/or peroxide in order to achieve the desire modification/crosslinking. Residual peroxide, phenolics, low molecular weight species formed from the decomposition of peroxide or phenolics, and other crosslinking agents can add to the undesirable odor and undesirable VOC emissions in the finished TPO skin product. For example, U.S. Pat. No. 6,114,486A teaches a rheology modification method, which involves reactive extrusion with a peroxide and/or a crosslinking agent; and the method of the above patent is not desirable due to odor and cost associated with reactive compounding and extrusion.

On the other hand, compounded TPO consisting of high melt strength POEs combined with low melt flow polypropylenes are often difficult to extrude due to the high melt viscosity of the compounded mixture. In addition, when known TPO soft skins are used for airbag deployment, the known TPO soft skins may not work properly because the elongation and tear strength properties of such TPO soft skins are often excessive due to the amount of elastomer or rubber incorporated into the known TPO soft skins. Thus, the excessive elongation and tear strength properties of such TPO soft skins makes it difficult for airbags to deploy without ballooning the TPO soft skin. It would be desirous to produce soft TPO skins that can provide enhanced processing and reduced tensile elongation and tear strength.

Generally, it is desired that TPO soft skins made from ethylene/α-olefin copolymers have a preferred melt flow rate (MFR), sometimes referred to as melt index (MI), determined in accordance with ASTM D1238-13 (Conditions: 190 degrees Celsius (° C.) for ethylene based olefins and 230° C. for propylene based olefins under a load of 2.16 kilograms [190° C./2.16 kg] or [230° C./2.16 kg]), of about 0.05 grams per 10 minutes (g/10 min) to 5.0 g/10 min.

Heretofore, a high melt strength polymer, such as ENGAGE, (available from The Dow Chemical Company) combined with a high melt strength or low melt flow (e.g., less than (<) 3 MI) polypropylene (PP) is used as a formulation for producing soft TPO skins as disclosed in “High Melt Strength Polyolefin Elastomer for Extrusion Profiles, Thermoforming, and Extrusion Blow Molding”, White Paper from SPE Automotive TPO Global Conference, October 2007; and in U.S. Pat. No. 9,938,385 which discloses an example including the use of PP with a MFR of <2.6 decigrams per minute (dg/min). The processes disclosed in the above references are not desirable because the resultant TPO skin formulation made by the above processes has an excessive melt viscosity; and the product made by the formulation has a high gloss, an excessive tensile elongation and/or tear strength at room temperature (RT; 23° C.) and/or higher than RT temperature.

Other references, for example, U.S. Pat. Nos. 8,431,651 and 6,828,384 disclose undesirable methods which result in a product with undesirable properties such as: (1) an excessive gloss level, (2) an excessive melt viscosity, (3) an unacceptable tensile property at RT and/or higher temperature, and/or (4) an unacceptable tear property at RT and/or higher temperature. For example, U.S. Pat. No. 8,431,651 discloses that the ratio of the melt tan delta of a very low density ethylene polymer component to the melt tan delta of a polypropylene (PP) component is in the range of from 0.5 to 4 as measured by parallel plate rheometer at 0.1 radians per second and at 180° C. For example, 6,828,384 teaches that linear low density polyethylene (LLDPE) is required and that the melt flow rate of the PP used must be less than 1.0. Use of LLDPE is undesirable because LLDPE increases hardness and a low melt flow rate of the PP results in high melt viscosity.

JP05830902B2 discloses a thermoplastic-elastomer composition containing 30 weight percent (wt %) to 70 wt % of polypropylene resin, component (A; and 30 wt % to 70 wt % of ethylene-alpha-olefin copolymer, component (B), whose Mooney stress relaxation areas in 125° C. is from 180 to 300. In the process described in JP05830902B2, the PP range of 30 wt % to 70 wt % is too wide to achieve the desired Shore A hardness of <95. An increased Shore A hardness of 95 or greater is not desired because the TPO skin would not feel soft and flexible to the touch at a Shore A hardness level of 95 or greater. In some instances, a concentration of PP of <40 wt %, and many instances a concentration of PP of <35 wt % is needed to achieve the desired hardness of the TPO skin. In addition, JP05830902B2 discloses profile extruded parts where the part dimensions originate from the extrusion die. As known in the extrusion art, “profile extrusion” describes extrusion of a shaped product having a variety of configurations but profile extrusion does not include sheet or film products. Extruded sheet for instrument and door panels coverings goes through a secondary operation where the sheet is heated and formed in a thermoforming tool in order to achieve the desired form and dimensions.

### SUMMARY

The present invention is directed to a TPO with several beneficial properties, including for example a TPO with: (1) a reduced tensile property and (2) a reduced tear property, while achieving: (3) a high melt strength, (4) an enhanced processing, and (5) a low gloss. In accordance with the present invention, a formulation is prepared wherein the formulation has an enhanced extrusion; and achieves: good melt strength, low gloss, a Shore A hardness of <95, a reduced tensile elongation, and a reduced tear strength.

In one embodiment, the present invention provides a process including combining a high melt strength POE with a high melt flow PP. For example, in a preferred embodiment the TPO composition of the present invention includes (a) an elastomer with a MFR of <1.0 in combination with (b) a polypropylene with a MFR greater than (>) 35 dg/min; wherein the polypropylene level can be from 20 wt % to 40 wt %. In the above preferred embodiment, the melt tan delta ratio between the ethylene and PP phase (180° C., 10 percent (%) strain, 0.1 radians per second (rad/s)) of the TPO composition of the present invention is >0.25.

In another embodiment, the elastomer skin composition includes, for example, (a) an ethylene-alpha polymer component and (b) a polypropylene component, wherein (i) the ethylene-alpha olefin is present at 60% to 80% by weight and consists of a high melt strength grade with fraction melt index of <1.0 MFR and with a density of from 0.85 grams per cubic centimeter (g/cc) to 0.89 g/cc; and wherein (ii) the polypropylene is present at 40% to 20% by weight and consists of a high melt flow grade with a melt index of >35 MFR.

In still another embodiment, a thermoformed soft TPO skin can be produced from the above elastomer skin composition, wherein the resulting TPO skin simultaneously exhibits: (1) an elongational viscosity ratio at 1.0:0.25 Hencky strains of >1.5; (2) a Shore A hardness of <95; and (3) a tensile elongation of <400% at RT and 95° C. when tested per ASTM D638-14 type V at 500 millimeters per minute (mm/min).

In yet another embodiment, the TPO skin of the present invention can be used to cover hard surfaces in the automotive interior, such as instrument panels, door panels, armrest and consoles.

### BRIEF DESCRIPTION OF THE DRAWINGS

FIG. 1 is a graphical illustration showing capillary viscosity measured for the compound containing ENGAGE 7387 and various polypropylenes with the polypropylene melt flow rates ranging from 0.5 dg/min to 120 dg/min.

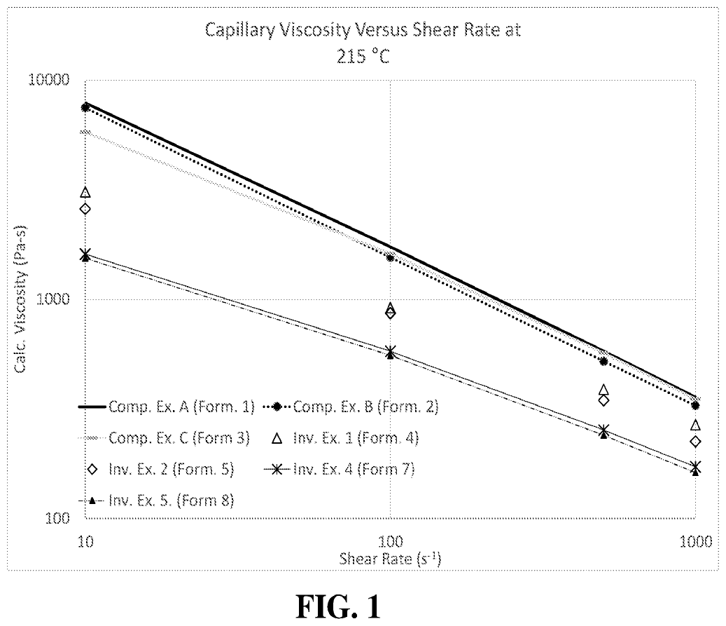

FIG. 2 is a graphical illustration showing elongational viscosity versus Hencky Strain for various formulations.

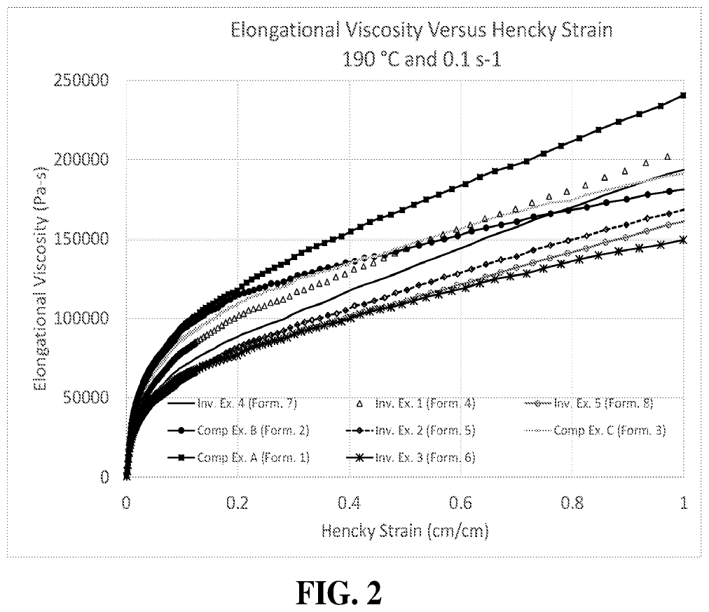

FIG. 3 is a bar graph showing elongational viscosity ratio for various formulations.

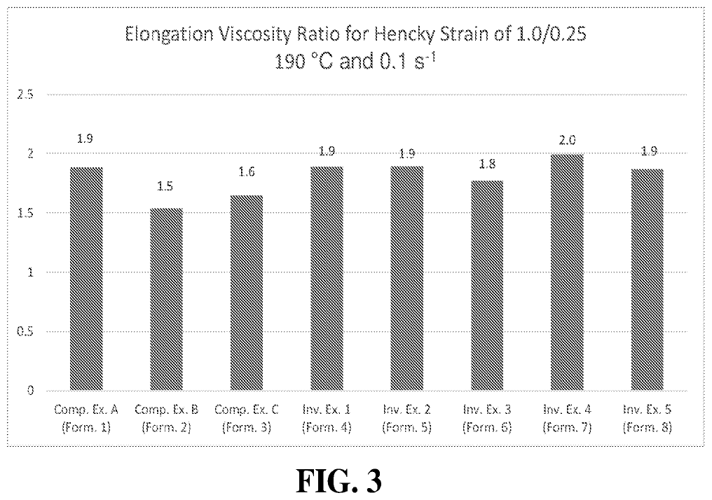

FIG. 4 is a bar graph showing 60 Degree Gloss for various formulations.

### DETAILED DESCRIPTION

In a broad embodiment, the thermoplastic olefin (TPO) composition of the present invention includes (a) an elastomer with a melt flow rate of <1.0 and a high melt strength, in combination with (b) a polypropylene with a melt flow rate of >35.

The elastomer compound that can be used to prepare the TPO composition of the present invention can include one or more elastomer compounds known in the art. For example, the elastomer compound can include one or more high melt strength POE compounds. “High melt strength” grades of POEs, herein means ethylene-alpha olefin elastomers with a melt index of <1.0 and a tan delta (G″/G′) of <2.5 when tested per dynamic mechanical spectroscopy at a rate of 0.1 rad/s and at 180° C.; and a strain of less than or equal to (≤) 10%.

For example, the elastomer compound can include ethylene/α-olefins interpolymers, optionally containing a diene, such as ethylene-butene copolymers and ethylene propylene diene monomers, and mixtures thereof. Examples of α-olefins useful in the present invention can include the α-olefins defined and described in paragraphs [0072] to [0078] of U.S. Patent Application Publication No. 2007/0167575, provided that the elastomer is high melt strength grade.

In a preferred embodiment, the elastomer compound can include commercially available elastomers such as ENGAGE 7487, 7387, and 7280 (available from The Dow Chemical Company); and the elastomer compound may include NORDEL 4785, 3745P, and 3722P (available from The Dow Chemical Company). In another embodiment, VISTALON™ and EXACT™ (available from ExxonMobil), and TARMER™ (available from Mitsui Chemical) may also be used in the present invention, provided that these products are offered in high melt strength grades.

The amount of elastomer compound used to prepare the TPO composition of the present invention can be, for example, from 60 wt % to 85 wt % in one embodiment, from 65 wt % to 80 wt % in another embodiment and from 70 wt % to 75 wt % in still another embodiment. If the elastomer level is greater than 85 wt %, then the resultant product might not have sufficient temperature resistance and parts formed from the material might soften or deform when exposed to temperature of 120° C.; which is considered the high-end exposure conditions for many instrument panel skins. If the elastomer level is lower than 60 wt %, then the Shore A hardness of the resultant product might be too high, resulting in a non-desirable hard feel.

Exemplary of some of the advantageous properties exhibited by the elastomer compound can include softness/haptics, flexibility, melt strength, and an exceptional long-term durability when combined with UV stabilizers.

The polypropylene compound that can be used to prepare the TPO composition of the present invention can include one or more polypropylene compounds known in the art with MFR greater than (>) 35 dg/min. For example, the polypropylene compound can include and a polypropylene component such as homopolymer polypropylene, impact copolymer polypropylene, and random copolymer polypropylene and mixtures thereof.

In a preferred embodiment, the polypropylene compound can include commercially available polypropylene compounds such as TI4900, TI7100, F1000HC, and CP1200B (available from Braskem Company); and Adstif HA801U and Adstif EA5076 (available from LyondellBasell), and mixtures thereof.

The amount of polypropylene compound used to prepare the TPO composition of the present invention can be, for example, from 15 wt % to 40 wt % in one embodiment, from 20 wt % to 35 wt % in another embodiment and from 25 wt % to 30 wt % in still another embodiment. If the polypropylene level is below the above described ranges, then the product might not have sufficient temperature resistance and parts formed from the material might soften or deform when exposed to temperature of 120° C.; which is considered the high-end exposure conditions for many instrument panel skins. If the polypropylene level is higher than the above described ranges, then the Shore A hardness of the product might be too high, resulting in a non-desirable hard feel.

Exemplary of some of the advantageous properties exhibited by the polypropylene compound can include improved high temperature stability (grain retention and dimensional stability) and reduced gloss.

In addition to the elastomer and the polypropylene, the TPO composition of the present invention may also include other additional optional compounds or additives; and such optional compounds may be added to the composition with either the elastomer or the polypropylene. The optional additives or agent that can be used to prepare the TPO composition of the present invention can include one or more optional compounds known in the art for their use or function. For example, the optional additive can include fillers (up to, for example 50 wt %), colorant, oil, antioxidants, ultraviolet light (UV) stabilizers, scratch/mar resistant additives, processing aids, and mixtures thereof. Other minor components known in the art to modify, for example, stiffness, appearance, softness, and processing can be added to the TPO composition.

The amount of optional compound used to prepare the TPO composition of the present invention can be, for example, from 0 wt % to 50 wt % in one embodiment, from 0.01 wt % to 40 wt % in another embodiment and from 2 wt % to 30 wt % in still another embodiment.

When an antioxidant is used, for example, if too little of the antioxidant is added to the composition, then degradation of the polymer can occur due to long term heat exposure and excessive processing temperatures. A typical level of the antioxidant can range from 0 wt % to 0.2 wt %.

When a UV stabilizer is used, for example, if too little of the ultraviolet light stabilizer is added to the composition, then the color of the TPO skin can fade or the physical properties of the skin can decrease due to UV exposure. A typical level of the ultraviolet light stabilizer can be <1 wt %.

In some embodiment, oil can be used to soften/reduce the Shore A hardness of the skin. A typical level of the oil can be <10 wt % in order to prevent oil blooming or reduce melt strength.

When a colorant is used, for example, the colorant level (usually in a masterbatch form) typically can be 0.5 wt % (no carrier) to 4 wt %. If the colorant level is too low, a poor color quality may result; and if the colorant level is too high, a decrease in physical properties may result.

When a filler is used, for example, the filler can range from 0 wt % to 30 wt %. Excessive filler content can result in high stiffness, hardness, or reduced thermoforming performance. When too low of filler content is used, a decreased performance in secondary operations such as laser welding and scoring may result.

In a general embodiment, the process for making the thermoplastic olefin (TPO) composition of the present invention includes the steps of admixing: (a) an elastomer with a melt flow rate of <1.0 in combination with (b) a polypropylene with a melt flow rate of >35.

In a preferred general embodiment, the TPO composition can be prepared by the steps of: (i) dry blending all of the components, other than colorant, and then (ii) feeding the dry blended material into a 42:1 25 millimeters (mm) co-rotating twin screw extruder produced by Century.

Using the above general process, a sheet can be extruded on a 1.5-inch Killion single screw extrusion line having a length to diameter of 24:1. A 12-inch coat hanger die can be used to produce a sheet (or film) with a thickness of 1.8 mm A three-roll stack with top roll containing a haircell grain can be used to embossed the film with approximately 170 microns (μm) deep grain and to cool the sheet. A general black colorant at a concentration of 2 wt % can be dry blended into the formulation of the present invention to provide color. Melt temperature and processing conditions are described in the Tables herein below.

The techniques and steps compounding the ingredients of the composition and the extrusion process can be performed using compounding equipment and extrusion processes known in the art.

Some of the advantageous properties exhibited by the TPO composition can include, for example, the capillary viscosity for the high flow PP can be low (which can, in turn, result in lower extruder pressures and higher extrusion rates); and the resulting sheet prepared from the TPO composition can exhibit a lower gloss.

As aforementioned, once the TPO composition of the present invention is made, the TPO composition can be used for making a product or article such as a TPO skin for automotive applications. In a general embodiment, the process for making a TPO article such as a TPO skin includes processing the TPO composition through a molding or extrusion process; or a grinding and slush molding process (for example, extruded and thermoformed skins can be prepared as described herein).

For example, in one embodiment, the TPO composition can be converted into a TPO skin by the following steps and conditions:

Step (1): Pellets are dry blended and compounded in an extruder, such as a twin-screw extruder. Typical melt temperatures can be, for example, from 200° C. to 240° C.

Step (2): The compounded pellets from above step (1) and a colorant are fed into a single screw extruder where the feed material is conveyed, melted, mixed/dispersed, and pumped through a slit die. The slit die controls the thickness and width of the sheet formed passing through the slit die. In one embodiment, a melt pump, in addition to the extruder, can be used to pump the material through the die to ensure a more uniform thickness. In another embodiment, the extruder in this step (2) can optionally be skipped, if a melt pump and die are used in step (1). In still another embodiment, the extruder in step (1) can optionally be skipped if the feed material is dry blended and directly extruded using a single screw extruder; i.e., in this embodiment, the components of the composition can be compounded and extruded using a single screw extruder (provided the single screw extruder produces sufficient dispersion and distribution), eliminating the need to compound using a twin screw extruder as described in step (1) above. Typical melt temperatures can be, for example, from 200° C. to 240° C. In yet another embodiment, the sheet formed in this step (2) can be melt laminated onto either a scrim or a TPO foam.

Step (3): The extruded sheet from above step (2) is passed through a roll stack to cool the material; and in an optional embodiment, the material can be embossed with a desired finish/grain.

Step (4): The sheet from above step (3) is then wound into rolls.

Step (5): In one optional embodiment, the sheet can be surface treated and painted with a polyurethane (PU) lacquer/topcoat to further reduce the gloss of the sheet; and to improve the scratch, mar, abrasion, and chemical resistance properties of the sheet. The topcoat formed in this step (5) is commonly cured, for example, at approximately (˜) from 100° C. to 120° C.

Step (6): The compact sheet (skin only) or bi-laminate (skin laminated onto foam) is then heated to a temperature of from 170° C. to 190° C. and thermoformed into the desired shape. For example, the thermoforming can be carried out via negative vacuum forming (where the grain comes from the mold surface). A smaller amount of thermoforming can be positively vacuum formed where the grain pattern is provided from the embossed sheet and retained during the thermoforming process.

Step (7): The thermoformed part from the above step (6) is then wrapped onto a substrate such as a hard instrument or a door panel surface. The thermoformed part is, for example, either glued into place or back-foamed with a urethane that affixes the skin onto the substrate through a skin-foam-substrate construction.

The skin construction of the present invention can include a structure made up of one or more layers, i.e., a single layer, a bi-layer, or multi-layer structure. In addition, the skin construction can also include a bi-laminate (TPO skin-TPO/PP foam), skin-scrim, skin-foam, and the like.

Skins can be coated with a topcoat having a thickness of up to 40 μm in one embodiment, from 5 μm to 40 μm in another embodiment, and from 10 to 40 μm in still another embodiment. The topcoat can advantageously be used, for example, to (1) enhance the scratch, abrasion, mar, and chemical resistance of the skin; (2) enhance the haptics of the skin, and/or (3) reduce the gloss of the skin.

Exemplary substrates that can be used for the topcoat of the skins can include topcoat products from Stahl based on a polyurethane dispersion (solvent or water based).

The TPO composition provides a TPO article, such as a TPO skin, which exhibits several beneficial properties, including for example: (1) a reduced tensile property; (2) a reduced tear property; (3) a high melt strength property, (4) an enhanced processing property; and (5) a low gloss property. For example, the tensile elongation of the TPO skin at 23° C. can be from 50% to >1,000% in one embodiment; from 100% to >750% in another embodiment, from 150% to 600% in still another embodiment; and from 200% to 400% in yet another embodiment. The tensile property of the TPO skin can be measured by, for example, ASTM D638. Test specimens are die cut to a specified geometry. Testing can be performed in the transverse direction of extrusion at a temperature of 23° C. Samples are tested per ASTM D638 with type V geometry at 500 mm/min.

For example, the tensile elongation of the TPO skin at 95° C. can be from 50% to 800% in one embodiment; from 75% to 500% in another embodiment, and from 90% to 400% in still another embodiment. Test specimens are die cut to the specified geometry. Testing can be performed in the transverse direction of extrusion at a temperature of 95° C. Samples can be tested per ASTM D638 with type V geometry at 500 mm/min.

For example, the tear strength property of the TPO skin can be from 10 kilonewtons per meter (kN/m) to 25 kN/m in one embodiment; from 12.5 to 25 kN/m in another embodiment, from 12.5 to 25 kN/m in still another embodiment; and from 15 to 22.5 kN/m in yet another embodiment. The tear property of the TPO skin can be measured by ASTM D624-00. Test specimens are die cut to obtain a standard trouser geometry. Testing can be performed in the machine direction of extrusion. Method ASTM D624 is utilized with a test temperature of 23° C. and at a rate of 500 mm/min.

For example, the melt strength ratio property of the TPO skin can be from >1 in one embodiment; from 1 to 4 in another embodiment from 1.25 to 4 in still another embodiment, from >1.4 to 4 in yet another embodiment; and from >1.5 to 4 in even still another embodiment. The melt strength property of the TPO skin can be measured by using an Extensional Viscosity Fixture (EVF) geometry and rotating drum design with a controlled strain rate of 0.1 s⁻¹ and tested at 190° C. Measurements are obtained using a TA Instruments ARES Classic RSAIII outfitted with the EVF geometry accessory. Elongational viscosity ratio is determined by dividing the elongational viscosity at 1.0 Hencky strain by the elongation viscosity at 0.25 Hencky strain.

For example, the enhanced processing property of the TPO skin can be observed for capillary viscosity at 215° C. reducing from 1,700 pascals seconds (Pa-s) to 550 Pa-s in one embodiment; from 1,600 Pa-s to 550 Pa-s in another embodiment, from 900 Pa-s to 550 Pa-s in still another embodiment. The enhanced processing property of the TPO skin can be measured by ASTM D3835-16 at 215° C. and X400-20 die (a 1.016 mm diameter×20.320 mm length die with a 120° cone angle) at a sheer rate of 100 s⁻¹.

For example, the gloss property of the TPO skin can be from 4.3 Gloss Unit (GU) to 1.3. GU in one embodiment; from 3.7 GU to 1.3 GU in another embodiment, from 2.9 GU to 1.3 GU in still another embodiment; and from 2.4 GU to 1.3 GU in yet another embodiment. The gloss property of the TPO skin can be measured by 60° gloss; and the skin can be measured in the transverse extrusion direction with a BYK Gardner 4561 Micro-Gloss Meter on the grained sides of the soft TPO skins (conforms to ASTM D 523).

The TPO composition can be used to manufacture various articles and the articles can be used in a variety of applications including, for example, TPO soft skins for automotive interior applications; artificial leather seating applications; and soft coverings for commercial, off road, and marine applications; and soft coverings for furniture surfaces applications.

### Examples

The following examples are presented to further illustrate the present invention in detail but are not to be construed as limiting the scope of the claims. Unless otherwise indicated, all parts and percentages are by weight.

Various ingredients, components, or raw materials used in the Inventive Examples (Inv. Ex.) and the Comparative Examples (Comp. Ex.) which follow are explained hereinbelow in Table I:

TABLE I
Raw Materials

| | PP⁽¹⁾ | | |
|---|---|---|---|
| Ingredient | No. | Brief Description | Supplier |
| ENGAGE ™ | — | Ethylene Copolymer: ethylene | The Dow |
| 7387 | | butene copolymer, 0.87 g/cc | Chemical |
| | | density, 0.5 MFR (190° C./ | Company |
| | | 2.16 kg), Tm = 50° C., 66 | |
| | | Shore A hardness. | |
| INSPIRE | PP1 | Polypropylene high melt | Braskem |
| 114 | | strength impact copolymer, | |
| | | 0.9 g/cc density, 0.5 MFR | |
| | | (230° C./2.16 kg) | |
| PP F006EC2 | PP2 | Polypropylene homopolymer, | Braskem |
| | | 0.5 MFR (230° C./2.16 kg) | |
| Pro-fax ™ | PP3 | Polypropylene random copolymer, | Lyondellbasel |
| SR257M | | 0.902 g/cc density, 2.0 MFR | |
| | | (230° C./2.16 kg) | |
| Poly- | PP4 | Polypropylene impact copolymer, | Braskem |
| propylene | | 35 MFR (230° C./2.16 kg) | |
| C700-35 | | | |
| Pro-fax ™ | PP5 | Polypropylene homopolymer, 0.9 | Lyondellbasel |
| PD702 | | g/cc density, 35 MFR (230° C./ | |
| | | 2.16 kg) | |
| Adstif | PP6 | Polypropylene homopolymer, 0.9 | Lyondellbasel |
| HA801U | | g/cc density, 65 MFR (230° C./ | |
| | | 2.16 kg) | |
| PP TI4900M | PP7 | Polypropylene impact copolymer, | Braskem |
| | | 0.9 g/cc density, 120 MFR (230° | |
| | | C./2.16 kg) | |
| F1000HC | PP8 | Polypropylene homopolymer, 0.9 | Braskem |
| | | g/cc density, 120 MFR (230° C./ | |
| | | 2.16 kg) | |
| Americhem | — | general black colorant | Americhem |
| 50083-H1- | | | |
| 100/ | | | |
| K10829-A | | | |

⁽¹⁾“PP” = polypropylene.

### Examples 1-5 and Comparative Examples A-C

General Procedure for Extrusion

Excluding colorant, the formulae described in Table II below were prepared by mixing the components and then compounding the components on a 42:1 25 mm. co-rotating twin screw extruder (available from Century) at a rate of ˜14.5 kg/hr.

The compositions of Comp. Ex. A-C are conventional formulations for producing soft TPO skins, where a high melt strength ethylene copolymer is utilized in combination with a low melt flow rate polypropylene. The compositions of Inv. Ex. 1-5 are prepared and tested to demonstrate that the desired properties for the composition of the present invention are achieved when utilizing a polypropylene with a melt flow rate of >35 dg/min.

TABLE II
Formulations (in Weight Percent)

| | Example No. (Formulation No.) | | | | | | | |
|---|---|---|---|---|---|---|---|---|
| | Comp. | Comp. | Comp. | Inv. | Inv. | Inv. | Inv. | Inv. |
| | Ex. A | Ex. B | Ex. C | Ex. 1 | Ex. 2 | Ex. 3 | Ex. 4 | Ex. 5 |
| Component | (Form.* 1) | (Form. 2) | (Form. 3) | (Form. 4) | (Form. 5) | (Form. 6) | (Form. 7) | (Form. 8) |
| Ethylene | 68.6 | 68.6 | 68.6 | 68.6 | 68.6 | 68.6 | 68.6 | 68.6 |
| Copolymers | | | | | | | | |
| PP1 | 29.4 | | | | | | | |
| PP2 | | 29.4 | | | | | | |
| PP3 | | | 29.4 | | | | | |
| PP4 | | | | 29.4 | | | | |
| PP5 | | | | | 29.4 | | | |
| PP6 | | | | | | 29.4 | | |
| PP7 | | | | | | | 29.4 | |
| PP8 | | | | | | | | 29.4 |
| Colorant | 2 | 2 | 2 | 2 | 2 | 2 | 2 | 2 |

*“Form.” = Formulation

The zone temperatures of the extruder were 140° C., 190° C., and 215° C. for zones 1, 2, and 4-9, respectively. A dual 3 mm hole strand die was utilized with at a temperature of 215° C. The extruder was run at a 200 revolutions per minute (RPM).

The compound pellets were extruded into sheet on the 1.5-inch, 24:1 length:diameter Killion single screw extrusion line. A 304.8 mm coat hanger die was used to produce sheet with a thickness of 1.8 mm A three-roll stack with top roll containing a haircell grain was used to emboss the film with ˜170 μm deep grain and cool the film. 2% of a general black colorant were dry blended into the formulations to provide color. Basic run conditions are described in Table III below and specific melt pressure and RPM for each formulation are reported in Table IV.

TABLE III
General Run Conditions for Sheet Extruding
on a 1.5-inch Killion Line

| Parameter | Setting | Note |
|---|---|---|
| Extruder RPM | Approximately 45 | Throughput estimated |
| | | at ~9.5 kg/hr |
| Barrel Zone 1, 2, | 175° C., 195° C., | Melt |
| 3, and clamp/adapter | 215° C., and 215° C. | temperature ~220° C. |
| temperatures | | |
| Die Zone 1, 2, | 218° C., 215° C., | |
| and 3 temperatures | and 218° C. | |
| Roll Stack | 44° C., 44° C., and | |
| temperatures (top, | 23° C. | |
| middle, and bottom) | | |

TABLE IV
Melt Pressures Observed During Sheet Extrusion

| | Formulation No. | | | | | | | |
|---|---|---|---|---|---|---|---|---|
| | Comp. | Comp. | Comp. | Inv. | Inv. | Inv. | Inv. | Inv. |
| | Ex. A | Ex. B | Ex. C | Ex. 1 | Ex. 2 | Ex. 3 | Ex. 4 | Ex. 5 |
| | (Form. 1) | (Form. 2) | (Form. 3) | (Form. 4) | (Form. 5) | (Form. 6) | (Form. 7) | (Form. 8) |
| Extruder RPM | 37 | 41.5 | 40.6 | 49 | 53 | 43 | 63 | 44 |
| Extruder Melt | 9.0 | 9.9 | 8.5 | 3.0 | 2.8 | 2.7 | 2.0 | 2.1 |
| Pressure (MPa) | | | | | | | | |

The melt pressure on the extruder decreased as the melt flow rate of the polypropylene increased. This is to be expected since fractional and low melt index polypropylenes will typically exhibit higher melt viscosities under processing shear rates. If an extruder is pressure or torque limited with a formulation (“Form.”) such as Form. 1 through Form. 3, then throughput can be increased by utilizing formulations, Form. 4 to Form. 8, with the high melt flow polypropylene.

### Experiment 1—Capillary Viscosity

Capillary viscosity is measured via ASTM D-3835. An X400-200 die ((1.016 mm diameter×20.320 length die with 120° cone angle) is utilized with a test temperature of 215° C. Polymer sheer rate ranges from 10 s⁻¹ to 1,000 s⁻¹.

Capillary viscosity decreases as the melt index of the polypropylene increases from 0.5 MFR to 35 MFR to 120 MFR. Formulations containing polypropylene with similar melt indexes exhibit similar melt indexes for the compounded system. Form. 1 contains 68.6% of a 0.5 MFR polypropylene. Form. 3, which contains a polypropylene with an MFR of 2, exhibits a decrease in melt viscosity of 26%, 7%, and 2% for shear rates of 10 s⁻¹, 100 s⁻¹, and 500 s⁻¹, respectively, when compared against Form. 1. Form. 4, which contains a polypropylene with an MFR of 35, exhibits a decrease in melt viscosity of 61%, 47%, and 33% for shear rates of 10 s⁻¹, 100 s⁻¹, and 500 s⁻¹, respectively, when compared against Form. 1. Form. 7, which contains a polypropylene with an MFR of 120, exhibits a decrease in melt viscosity of 80%, 67%, and 57% for shear rates of 10 s⁻¹, 100 s⁻¹, and 500 s⁻¹, respectively, when compared against Form. 1.

### Experiment 2—Extensional Viscosity at 190° C.

Extensional viscosity measurements were made using a TA Instruments ARES Classic RSAIII outfitted with an EVF geometry accessory. The EVF geometry consists of a dual barrel design. The barrel connected to the instrument transducer (upper) remains stationary and records force, which is converted to torque. The barrel connected to the instrument motor rotates in the clockwise direction while revolving around the center barrel, also in the clockwise direction.

10 mm wide rectangular strips were punched out of the provided 0.6 mm thick sheet (compression molded to the thickness) using a Charpy die in combination with a hydraulic press. The strips were cut using scissors, down to (4) 20 mm length test specimens.

The test environment was controlled by using the forced convection oven (FCO) on the ARES. The FCO utilizes a plant nitrogen environment and measures the temperature with one platinum resistance thermometer within the oven chamber space. Upon installing the EVF geometry, the instrument was given roughly 45 minutes (min) of preheat time at 190° C. to ensure that the entire geometry had equilibrated at the testing temperature. Once a sample has been loaded, and a test started, a 120 seconds (s) delay was built into the extensional viscosity method to allow the test specimen time to equilibrate. Even with the delay, the instrument will still wait until the oven air temperature is within a +/−0.10° C. window to start the test. From the time a sample was loaded into the clamps, it took roughly 220 s for the test's pre-stretch step to begin.

The EVF geometry method started with a built-in pre-stretch to correct any sag that develops in the sample caused by thermal expansion during the pre-heat. The pre-stretch distance and rate was chosen by the operator. The intent of the pre-stretch portion of the test was to bring the sample slightly into tension, followed by a relaxation period (operator controlled) where the sample should return to a tension near 0 grams-force. Once the pre-stretch portion of the test was complete, the programmed extensional viscosity experiment began. In the case of the metal fiber filled samples, pre-stretch and relaxation lengths and times were set to a default value of 0.05 mm and 30 s respectively in most cases. Relaxation times were changed depending on if the particular sample needed more or less time to return to a zero-force starting point.

The EVF geometry experiments were performed with a controlled strain rate of 0.1 s⁻¹. Using said strain rate, each experiment took 40 s to complete. At the end of each test, the sample was removed from the clamps, the fixtures were cleaned using a brass brush, and the oven was shut again and allowed to return to 190° C.

This elongation viscosity test measures viscosity as a function of Hencky strain. For thermoforming applications, it is desired that the elongational viscosity increases as the strain increases. Many parts may experience draw during thermoforming of up to 100% (1 Hencky strain). If the viscosity doesn't increase significantly as the part draws, then local thinner or tearing can occur in high draw areas. It is desired that the elongational viscosity ratio at 1.0:0.25 Hencky strains be >1.5 to prevent areas that are locally strain to high levels from further straining, which could result in thinning or tearing.

The elongational viscosity ratio at 1.0:0.25 Hencky strains for all samples tested are >1.5. Increasing the MFR of the polypropylene component doesn't cause the value to decrease. This study indicates that all parts should form well given the similar slopes of the increase in elongational viscosity versus Hencky strain.

### Experiment 3—Shore A Hardness

As described in Table V, the Shore A hardness of all formulation samples described in Table V is <95. These samples are tested per ASTM D2240-15 with a 10 second delay.

### Experiment 4—Tensile Elongation at Room Temperature

As described in Table V, the room temperature (23° C. and 50% relative humidity [RH]) tensile elongation for formulation samples containing polypropylene with a MFR of <35 is >400%. All formulation samples containing polypropylene with a MFR of >35 exhibit a tensile elongation of <400%.

The tensile property of the TPO skin can be measured by, for example, ASTM D638. Test specimens are die cut to a specified geometry. Testing can be performed in the transverse direction of extrusion at temperatures of RT. Samples are tested per ASTM D638 with type V geometry at 500 mm/min.

### Experiment 5—Tensile Elongation at 95° C.

As described in Table V, the tensile elongation at 95° C. for formulation samples containing polypropylene with a MFR of 0.5 and 2.0 is >400%. All formulation samples containing polypropylene with a MFR of >35 exhibit a tensile elongation of <400%.

The tensile property of the TPO skin can be measured by, for example, ASTM D638. Test specimens are die cut to a specified geometry. Testing can be performed in the transverse direction of extrusion at temperatures of 95° C. Samples are tested per ASTM D638 with type V geometry at 500 mm/min.

### Experiment 6—Tear Strength at Room Temperature

As described in Table V, the room temperature tear strength (23° C. and 50% RH) for formulation samples containing polypropylene with a MFR of <35 is ≥20 kN/m. All formulation samples containing polypropylene with a MFR of >35 exhibit a tear strength of <20 kN/m. Therefore, formulation samples containing polypropylene with a MFR of >35 may be more desirable for applications requiring a reduced tear strength.

The tear property of the TPO skin can be measured by ASTM D624. Test specimens are die cut to obtain a standard trouser geometry. Testing can be performed in the machine direction of extrusion. Method ASTM D624 is utilized with a test temperature of 23° C. and at a rate of 500 mm/min

TABLE V
Summary of Test Results for Experiments 3-6

| | Example No. (Formulation No.) | | | | | | | |
|---|---|---|---|---|---|---|---|---|
| | Comp. | Comp. | Comp. | Inv. | Inv. | Inv. | Inv. | Inv. |
| | Ex. A | Ex. B | Ex. C | Ex. 1 | Ex. 2 | Ex. 3 | Ex. 4 | Ex. 5 |
| Test | (Form. 1) | (Form. 2) | (Form. 3) | (Form. 4) | (Form. 5) | (Form. 6) | (Form. 7) | (Form. 8) |
| Elongation | 1.9 | 1.5 | 1.6 | 1.9 | 1.9 | 1.8 | 2.0 | 1.9 |
| Viscosity Ratio | Pass | Pass | Pass | Pass | Pass | Pass | Pass | Pass |
| (Pass or Fail) | | | | | | | | |
| Shore A < 95 | 87 | 87 | 87 | 85 | 89 | 92 | 87 | 90 |
| (Pass or Fail) | Pass | Pass | Pass | Pass | Pass | Pass | Pass | Pass |
| Tensile | 479 | 463 | 578 | 421 | 420 | 321 | 238 | 184 |
| Elongation RT | Fail | Fail | Fail | Fail | Fail | Pass | Pass | Pass |
| (%) | | | | | | | | |
| Tensile | 402 | 773 | 539 | 150 | 258 | 173 | 101 | 92 |
| Elongation 95 | Fail | Fail | Fail | Pass | Pass | Pass | Pass | Pass |
| ° C. (%) | | | | | | | | |
| Tear Strength at | 20 | 26 | 32 | 20 | 23 | 19 | 17 | 17 |
| RT (kN/m) | | | | | | | | |

### Experiment 7—60 Degree (60°) Gloss

60° gloss was measured in the transverse extrusion direction with a BYK Gardner 4561 Micro-Gloss Meter on the grained sides of the soft TPO skins. In addition, the 300 mm×100 mm×0.7 mm skin appearances were noted.

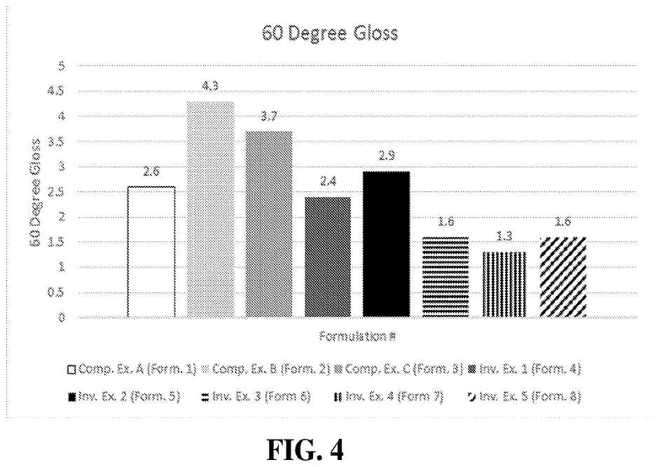

As shown in FIG. 4, gloss levels decrease for the soft TPO sheet containing polypropylene with a MFR of >35. This is desirable since many OEM desire gloss levels of soft TPO skins to be <2.0.

What is claimed is:

1. A thermoplastic olefin composition comprising:
(a) an elastomer having a melt flow rate of less than 1.0 decigrams per minute and having a high melt strength of tan delta of less than 2.5; wherein the concentration of the elastomer is a ratio from 0.6 to 0.8 of elastomer to polypropylene; and
(b) a polypropylene having a melt flow rate of greater than 35 decigrams per minute and present in a concentration of greater than or equal to 0.2 ratio of polypropylene to elastomer;
wherein the thermoplastic olefin composition provides a compound having a Shore A hardness of less than 95 and an elongational viscosity ratio at 1.0:0.25 Hencky strains of greater than 1.5.

2. The composition of claim 1, wherein the elastomer, component (a), is an ethylene-alpha polymer component.

3. The composition of claim 1, wherein the elastomer, component (a), has a density of between 0.85 and 0.89 grams per cubic centimeter.

4. The composition of claim 1, wherein the elastomer is an ethylene-alpha olefin elastomer having a melt index of less than 1.0 and a tan delta of less than 2.5 when tested per dynamic mechanical spectroscopy at a rate of 0.1 radian/second and at 180° C., and a strain of less than or equal to 10 percent.

5. The composition of claim 1, wherein the ratio of the melt tan delta of the elastomer the melt tan delta of the polypropylene is less than 0.25 as measured by parallel plate rheometer at 0.1 radians per second and at 180° C.

6. The composition of claim 1, wherein the concentration of the polypropylene, component (b), is a ratio from 0.2 to 0.4 of polypropylene to elastomer.

7. A process for making a thermoplastic olefin composition comprising admixing (a) an elastomer with a melt flow rate of less than 1.0 decigrams per minute in combination with (b) a polypropylene with a melt flow rate of greater than 35 decigrams per minute.

8. A thermoplastic olefin skin article made from the composition of claim 1, wherein the article simultaneously exhibits: (1) an elongational viscosity ratio at 1.0:0.25 Hencky strains of greater than 1.5; (2) a Shore A hardness of less than 95; and (3) a tensile elongation of less than 400 percent at 23° C. and at 95° C. when tested per ASTM D638-14 type V at 500 millimeters per minute.
